(19) United States
(12) Patent Application Publication
(10) Pub. No.: US 2021/0206048 A1
(43) Pub. Date: Jul. 8, 2021

(54) STEM WITH SECONDARY CURVATURE IN EXTENSION

(71) Applicant: RTL Materials Ltd., Lymington Hampshire (GB)

(72) Inventor: Andrew Daton-Lovett, Lymington (GB)

(21) Appl. No.: 16/067,212

(22) PCT Filed: Dec. 31, 2015
(86) PCT No.: PCT/GB2016/054052

§ 371 Date: Jun. 29, 2018

(30) Foreign Application Priority Data
Dec. 31, 2015 (GB) 1523158.2

(51) Int. Cl. B29C 61/06

(52) U.S. Cl. CPC B29C 61/0633

(57) ABSTRACT

The present invention relates to a STEM with secondary curvature in extension and to methods of manufacture. In an aspect, an extendible member (10) is provided which is configurable between a coiled form (11) and an extended form (12). The member comprises a longitudinal shell resiliently biased in a slit tube form in which it has a first curvature relative to the hoop of slit tube and has a secondary curvature relative to the longitudinal axis of the member. The slit tube can be opened out at the slit to assume an open form in which it has a flattened cross section in transitioning from the extended form to the coiled form. The strain energy when coiled is lower than the peak strain energy in the member when transitioning from the extended to the coiled form.

The present invention relates to a slit tube extendible member (STEM) with secondary curvature in extension and to methods of manufacture.

It is difficult to make extendable structures which when extended have a curved form relative to the axis of extension.

Telescopic members with a curved extended form can be manufactured, but do not work well with anything other than a slight and constant curvature. In addition, they also always have the characteristic of being thinner at one end than at the other, which often sits in line with the load regiment of a straight or almost straight member but is awkward when the object is to make a ring or toroidal structure or anything in which a constant or close to constant cross sectional diameter is desirable.

When it comes to trying to make an extendible member with a non-constant and/or non-circular secondary curvature it become almost impossible using conventional techniques. A changing curve just cannot nest neatly inside an adjacent element without occupying a large internal gap with a tighter radiused element, with no possibility of neat sliding between inner and outer surfaces.

There are many examples where a curved extendable member may be desirable, where it is preferable to deploy the member from a form in which it is relatively small and when extended provides structural rigidity so as to be capable of supporting any desired load.

What is needed is extendible members that mitigate such problems, and ways of manufacturing such devices.

According to an aspect of the present invention, there is provided an extendible member which is configurable between a coiled form and an extended form, comprising a longitudinal shell resiliently biased in a slit tube form in which it has a first curvature relative to the hoop of the slit tube and has a secondary curvature relative to the longitudinal axis of the member, wherein the slit tube can be opened out at the slit to assume an open form in which it has a flattened cross section in transitioning from the extended form to the coiled form, wherein the strain energy when coiled is lower than the peak strain energy in the member when transitioning from the extended to the coiled form.

According to another aspect of the invention, there is provided an extendible member having a secondary curvature when extended, running substantially along the axis of extension or retraction.

Thus, when extended, the member can form rigid structures with various curvatures allowing a wide variety of additional applications. The member can be coiled for easy storage, transportation and deployment by virtue of the coiled state having lower stored strain energy than the peak strain energy when the member is transforming from its extended to coiled form. The member may be bistable, having a stable form when coiled and when extended.

There are many examples where a curved extendable member may be desirable, such as the ability to form circular hoops to support reflective antennas, planar spirals to provide in-plane rigidity to membrane structures and the ability to extend a whole range of arch-like structures, whether circular, parabolic or non-uniform in section to provide support for structures. Such members can be used in a variety of industries, such as space applications, oil exploration, etc., where the deployment of booms, masts, and other load supporting structures in small spaces is desirable. Such members could also be of benefit in the erection of tents or other temporary structures where an arch allows the support of fabric covers without occupying internal space. Alternatively such a member or members may be linked along the edges or axially in such a manner as to form a rigid or semi-rigid structure from the linked members. Such methods may be combined to form hybrid structures in any manner found to be of utility for a particular task.

The secondary curvature may be a conic section, regular or irregular spline curve or spiral or helical curves or any other curve or combination of curves or combination of curved and straight sections.

The member may be coiled on a reel or bobbin or other support structure. The member may have a drive mechanism to help coil and/or uncoil the member. Alternatively, the member may be coiled and/or uncoiled by hand.

The member when extended may be have any desired length and may be significantly longer when extended to its size when coiled, e.g. having an extended length at least 5 times the width of the member, and/or the coil having at least 5 turns.

The member may comprise a fibre reinforced composite.

The direction of fibre reinforcement may be modified around the hoop of the extended structure in such a manner as to reduce the peak strain in the structure during coiling.

The direction of fibre reinforcement may be modified along the axis of the extended structure in such a manner as to reduce the peak strain in the structure during coiling.

The direction of fibre reinforcement may be modified around the hoop of the extended structure in such a manner as to reduce the peak strain in the structure during coiling and in such a manner as to cause the member to exhibit bi-stability.

The direction of fibre reinforcement may be modified along the axis of the extended structure in such a manner as to reduce the peak strain in the structure during coiling and in such a manner as to cause the member to exhibit bi-stability.

In an embodiment, the curvature, in whole or in part, derives from or is modified by the local effects of shrinkage in the matrix polymer or adjustments in reinforcement such as to prevent shrinkage locally. For instance, in a lamina layer of the composite member, additional reinforcing fibres running in the longitudinal direction or having a significant component in the longitudinal direction (e.g. >60 degrees to the longitudinal axis) may be present only in the centre of the member but not extend to the sides of the member, or may be more closely aligned with respect to the longitudinal axis so as to provide higher resistance to shrinkage in the longitudinal axis in this area of higher reinforcement. Thus, for instance, the member may be formed on a straight former, and the matrix cured, the areas without the reinforcement shrink more than the reinforced areas in a longitudinal direction causing pretention in the cured member. When removed from the former, the edges of the member contract relative to the centre of the member, which, due to the primary curve, causing it to bend into the secondary curve.

All or part of the reinforcement may have the property of being possessed of a negative Poisson's ratio, thus producing a structure such that the intrados face of the extended structure becomes the extrados face of the coiled structure when coiling in such a manner as to produce the lowest peak and mean strain within the structure during coiling, contrary to normal stress-strain relationships during coiling.

According to another aspect of the invention, there is provided a method of forming an extendible member as described above, in which the shape is derived from being formed on a male or female mould of the desired shape.

According to another aspect of the invention, there is provided a method of forming an extendible member as described above, in which the form produced by a mould is modified by the effects of shrinkage or local reinforcement acting to prevent shrinkage.

According to another aspect of the invention, there is provided a method of forming an extendible member as described above in which the shape is derived from a composite material being consolidated on the flat whilst enclosed on both faces by conveyor type belts and then being passed, along with said belts, through a die that imparts both primary and secondary curvature.

According to another aspect of the invention, there is provided a method of forming an extendible member as described above in which the curvature, in whole or in part, derives from or is modified by the local effects of shrinkage in the matrix polymer or adjustments in reinforcement such as to prevent shrinkage locally.

The above described techniques can be combined to produce members of various forms, as described by the examples. In embodiments, the techniques can be applied locally, or to different degrees locally, to produce members having straight longitudinal sections and curved longitudinal sections, and/or differently curved sections.

In preferred embodiments, the elongate member comprises a fibre reinforced composite material. This provides a particularly convenient way of making the sensor assembly.

The member may be formed from a sheet-like material having first and second longitudinal edges that is folded in on itself longitudinally to form a tube or a longitudinal section of a tube when the member is in the extended form.

The member may be constructed such that, in transverse cross section, the extended form of the member subtends any one from a wide range of angles. As will be appreciated, the angle can be chosen to be relatively small, but should be large enough to give stiffness to the extended member to aid in deployment and control the positions and/or tensions of the sensors running along the member. For example, an angle greater than 20 degrees will be preferred in most cases. Using a larger angle can be useful in some cases to give additional stiffness. The angle can be 360 degrees or more, so the edges meet or overlap allowing a “closed” tube to be formed, which may be desirable in some situations. However, in some embodiments, the angle may be between 45 and 170 degrees. Preferably in transverse cross section the extended form of the member is generally curved.

The member may be formed from a bistable material having a first stable form when it is in the coiled form and a second stable form when it is in the extended form.

The radius of secondary curvature may be less than 100 meters, or less than 50 meters, or less than 20 meters. Put another way, relative to the width of the coiled member, the radius of secondary curvature may be less than 50 times the width of the member, less than 20 times the width of the member, or less than 10 times the width of the member.

It will be appreciated that any features expressed herein as being provided “in one example” or “in an embodiment” or as being “preferable” may be provided in combination with any one or more other such features together with any one or more of the aspects of the present invention. In particular, the extendible member, joining techniques and join testing system described in relation to one aspect may generally be applicable to the others.

Embodiments of the present invention will now be described by way of example with reference to the accompanying drawings, in which:

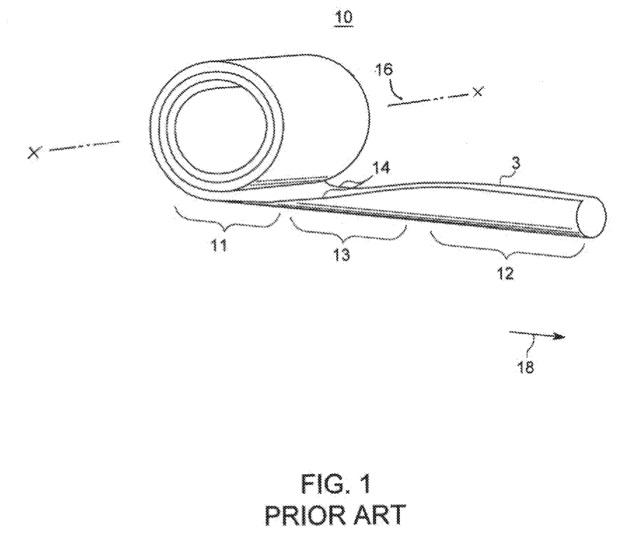

FIG. 1 shows an example of a (STEM) slit tube extendible member;

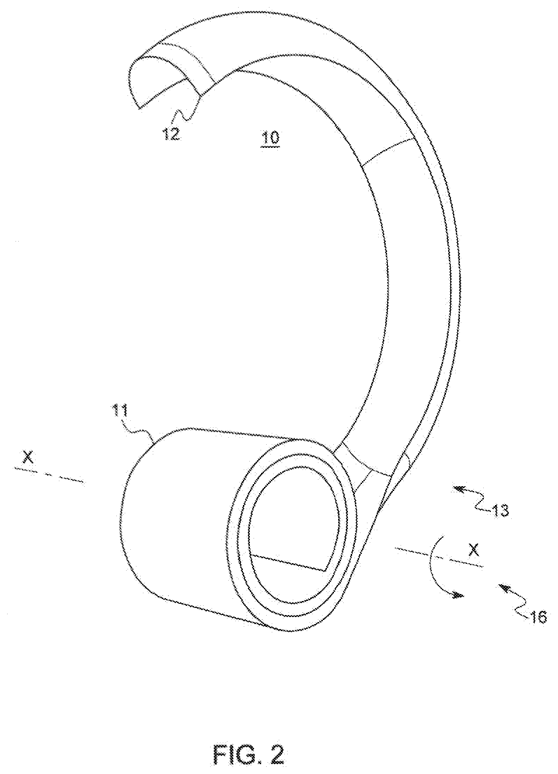

FIGS. 2 to 8 show examples of extendible members according to embodiments of the invention having various extended forms with secondary curves;

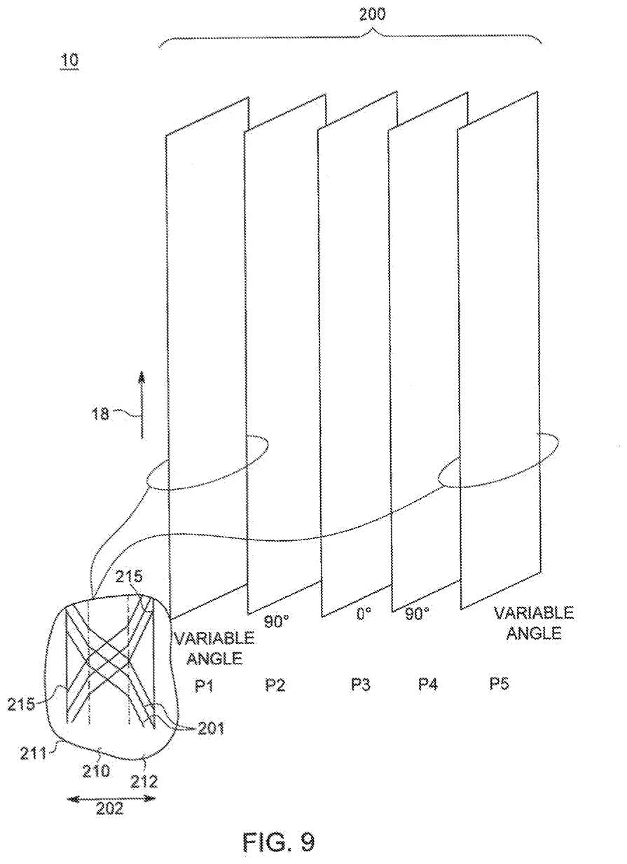

FIG. 9 shows an example of a layup for a composite member according to an embodiment of the present invention;

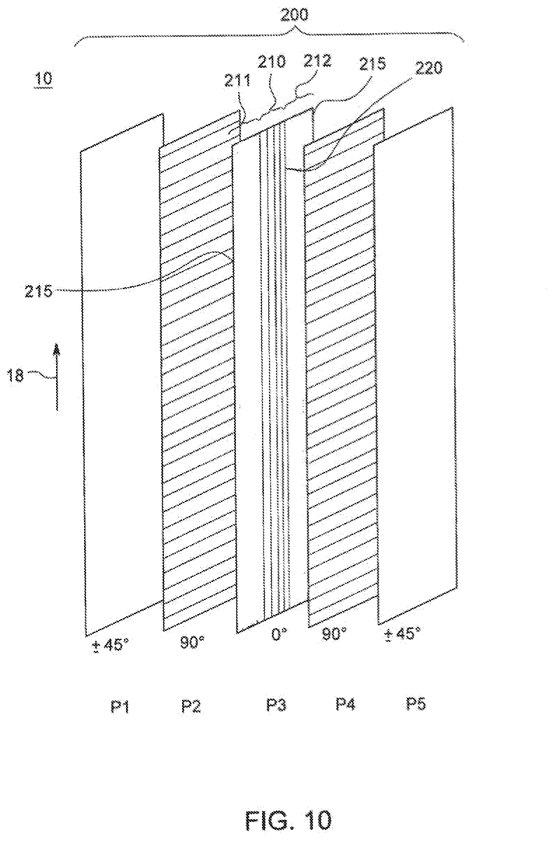

FIG. 10 shows another example of a layup for a composite member according to an embodiment of the present invention;

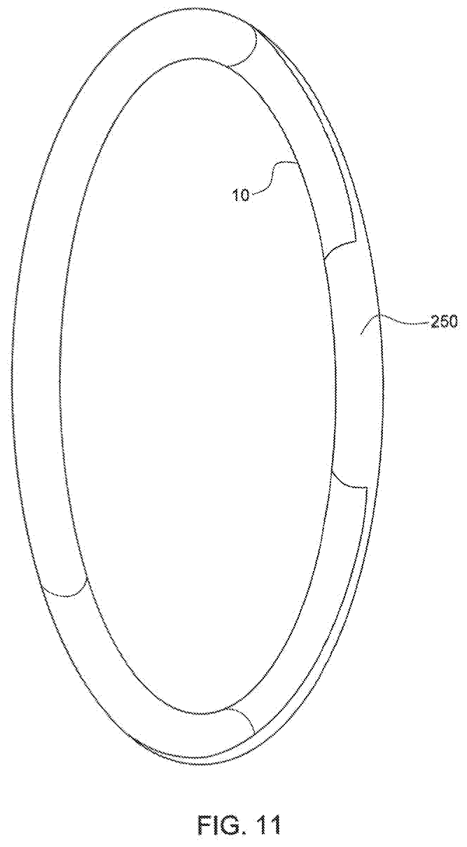

FIG. 11 shows an example of apparatus for manufacturing a member according to an embodiment of the present invention;

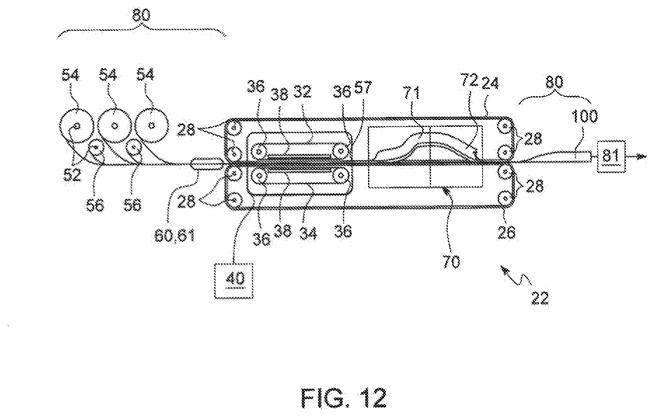

FIG. 12 shows another example of apparatus for manufacturing a member according to an embodiment of the present invention,

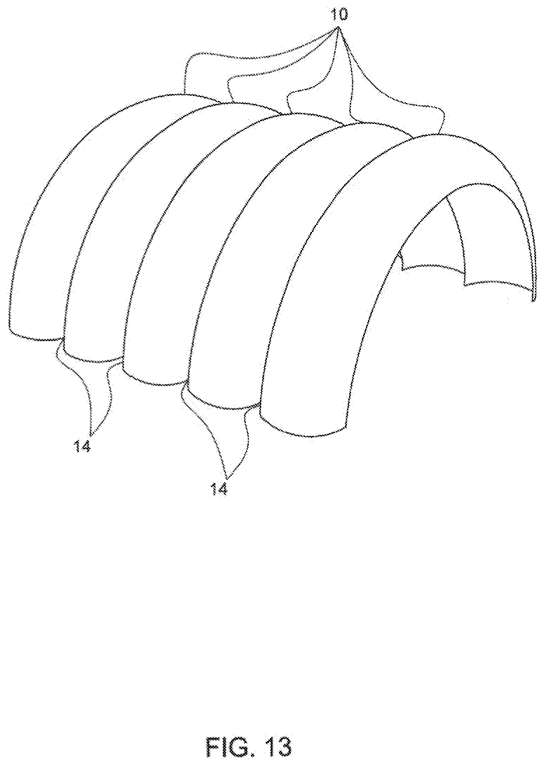

FIGS. 13 to 15 show examples of compound extendible members according to embodiments of the invention; and,

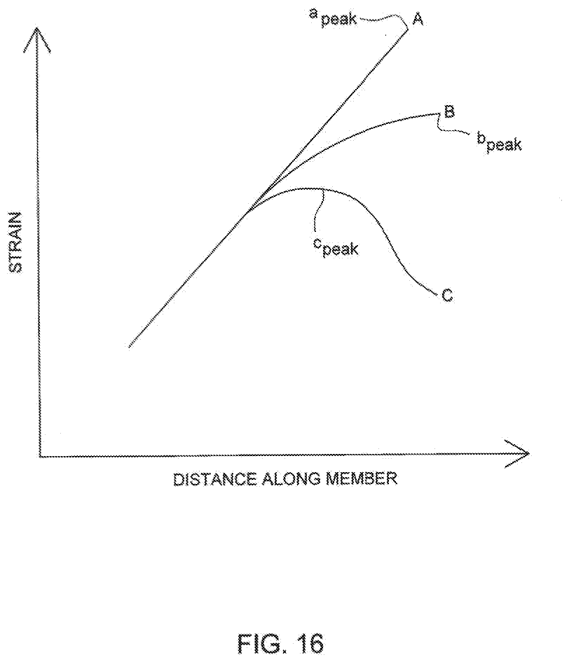

FIG. 16 shows a plot of strain in a member transitioning from being coiled to being extended.

FIG. 1 shows an example of an extendible member 10. The member 10 can be reconfigured between a coiled state 11 and an extended state 12, via a transition stage 13. In the extended state 12 the member is generally elongated and biased to have a curved or non-linear cross section in a direction transverse to the longitudinal axis 18 of the member. (References to longitudinal axis or longitudinal extent or direction of extension or retraction in this document generally refer to this axis 18). Thus, the longitudinal edges 14 form a slit 3 in the generally curved, tubular form. This curvature can be adapted and thus the cross section of the extended portion can comprise anything from a closed or substantially closed circular shape, or other generally closed shapes. The member 10 is resiliently biased in this curved cross section when extended. This gives structural rigidity to the member 10 when extended. In the coiled state 11 the member 10 is generally opened out at the side longitudinal edges 14 to have a flat cross section, and is coiled around an axis 16 that is transverse to the longitudinal axis 18 of the member 10. The member 10 comprises a thin shell to aid coiling, e.g. typically between 0.5 mm and 5 mm for most applications. Such members are sometimes referred to as STEMs (Slit Tubular Extendable Members).

In the present example, the member 10 comprises a composite material having a thermoplastic matrix with fibre reinforcements, such as a fibre reinforced polymer (“FRP” hereafter). The fibres may be glass, carbon, or aramid, while the polymer may be polypropylene, polyethylene, a polyamide, polyester thermoplastic, poly-ether-ether-ketone or any other polymer suited to the particular requirements of the task at hand. The composite material may comprise a single layer or plural layers with fibres oriented in different directions in each lamina. The use of fibrous materials mechanically enhances the strength and elasticity of the plastic matrix. The extent that strength and elasticity are enhanced in a fibre reinforced plastic depends on the mechanical properties of both the fibre and the matrix, their volume relative to one another, and the fibre length and orientation within the matrix. FRPs are widely used in many areas such as aerospace and automotive industries, and are not described in detail herein.

In the present example, the member 10 is a bistable reelable composite (BRC). Such a bistable member has a first stable state in the coiled form 11, where the cross section of the member 10 is generally flat and a second stable state in the extended form 12, where the cross section of the member is curved as previously described. The bistable member 10 may be capable of reversible configuration between its coiled and extended forms a plurality of times. Suitable structures are disclosed in the following international patent applications, each of which is incorporated here by reference: WO A 88/08620, WO-A-97/35706, WO-A-99/62811, and WO-A-99/62812. Such bistable structures are available from RolaTube Technology Limited of Lymington, the United Kingdom.

In general, there are two ways to make a tube bistable; either by altering the bending stiffnesses of the structure so that it is no longer isotropic, for instance by using a fibre-reinforced composite, or by setting up an initial prestress in the structure. The BRC in the present example uses the first technique. This involves arranging the fibres to increase the torsional stiffness, and increase the coupling between bending in the longitudinal and transverse directions. This can be achieved by ensuring that in the surface layers of the BRC, i.e. those offset from the midplane of the BRC, stiff fibres are angled relative to the longitudinal axis, e.g. at ±45°. A simple example is the anti-symmetric [+45/−45°/0°/+45°/−45°] fibre lay-up.

In engineering terms these surface layers have high Poisson's ratios. It is well known that as a curved shell is straightened the inner surface gets longer and the outer surface gets shorter. Thus, when a section of the extended tube is opened, as the initial curvature straightens, the surface fibres are deformed which, due to their high Poisson's ratio, exert a force acting to curve the opened section longitudinally into its coiled form. The tube coils with same sense curvature, i.e. the centre of curvature is on the same side of the structure in both forms.

Normally when something is bent the amount of energy stored by that bending (the total strain energy) rises as the degree of bending increases. In BRCs, once the initial curvature is straightened as the tube is opened, the stiffness along the longitudinal axis drops and the forces acting on the material of the tube arising by the deformed surface fibres can act to flip it into the coiled form. As this second curves forms, the total strain energy drops, thereby forming a second stable form, or more stable form, for this section.

These principle operate in reverse when moving from the coiled state to the extended state.

Thus, structural members 10 are formed that exhibit a stable geometry in both the extended and coiled states. These manage the problems of difficult handling and complicated mechanisms by forming STEM type structures from materials that have been engineered so as to make them easy to coil and handle.

The present inventor has found that the structures and techniques described in relation to FIG. 1 in making STEMS can be applied and extended to make members 10 having non-straight extended forms as described in the following. A STEM type structure may have a secondary curvature when extended (the primary curve being transverse to the extension direction—i.e. in the cross section of the extended member—to give structural rigidity to the extended member), running substantially along the axis of extension or retraction. This curvature may be of any conic section, regular or irregular spline curve or spiral or helical curves or any other curve or combination of curves or combination of curved and straight sections. Examples are shown in FIGS. 2 to 8.

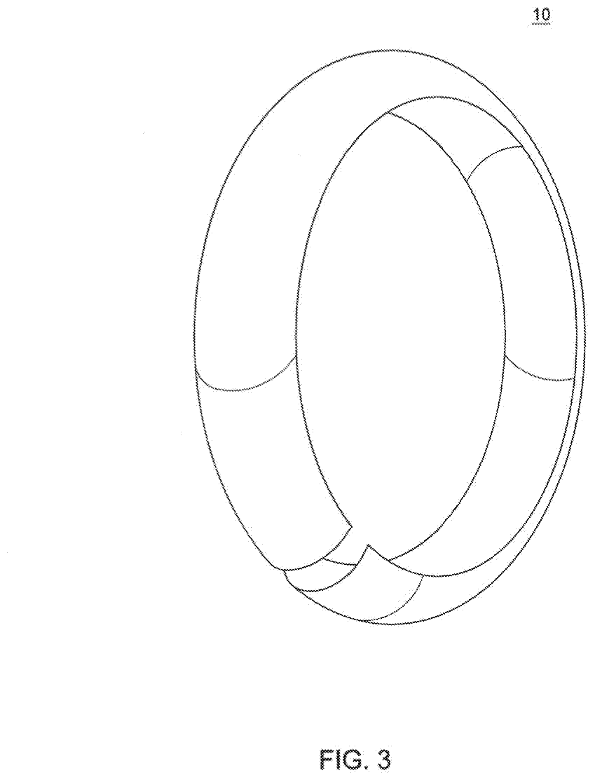

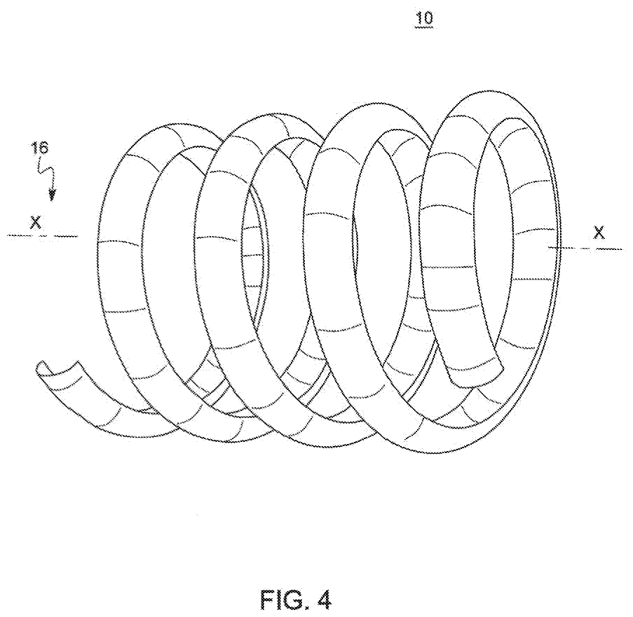

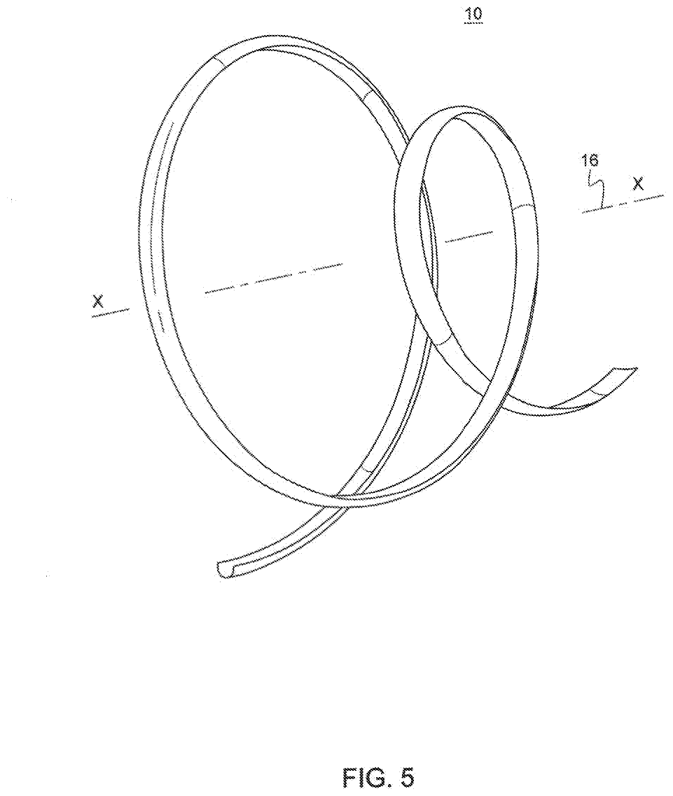

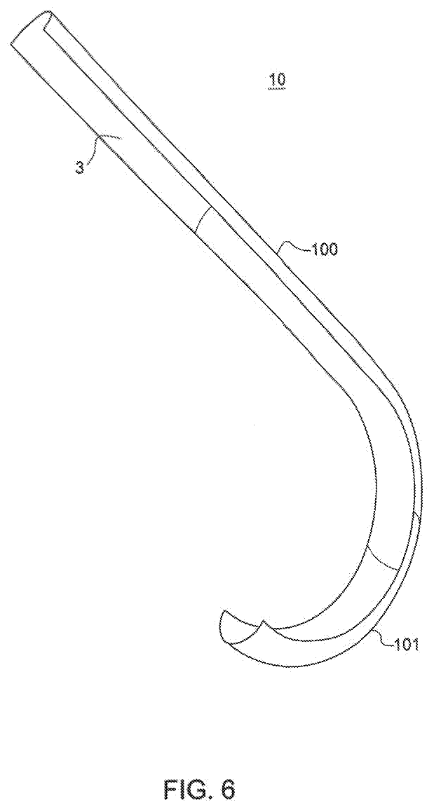

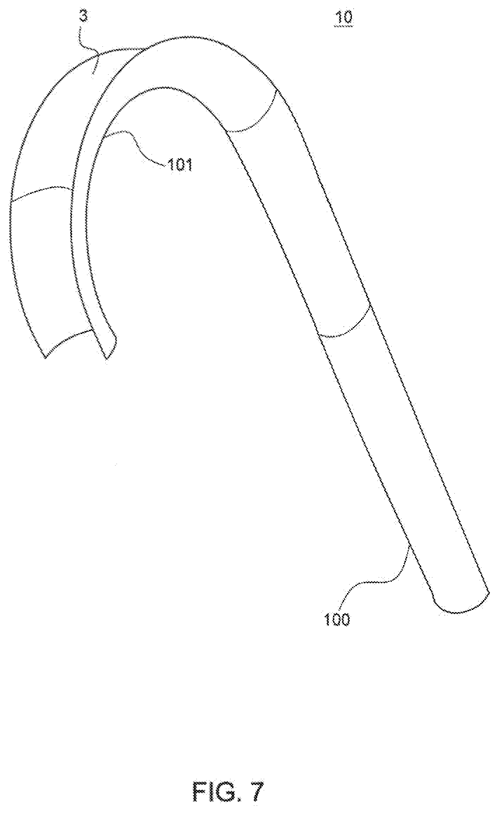

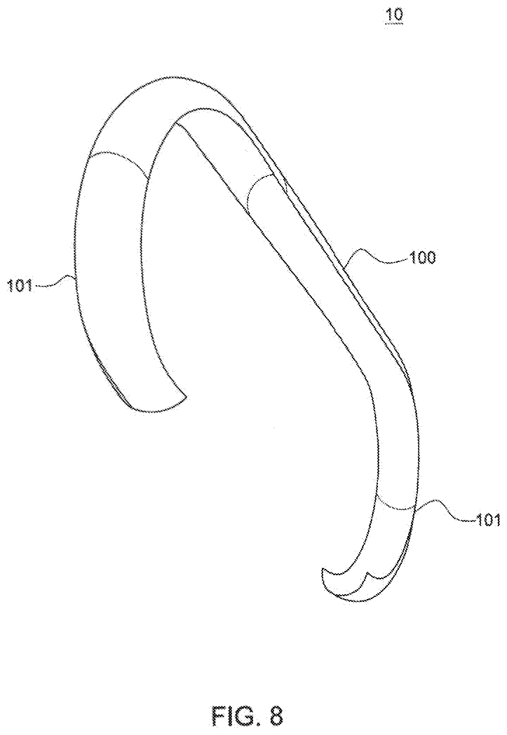

FIG. 2 shows a member 10 having, when extended, a secondary curve about the axis 16 of the coil so as to form a toroid, the member 10 in the process of transitioning 13 from the coiled form 11 to the extended toroid form 12. FIG. 3 shows a member forming a torus, i.e. extending with a constant secondary curvature in a plane. FIG. 4 shows a member 10 having a helical extended form, where the secondary curve is both about the axis of the coil (as in the examples of FIGS. 2 and 3) and with a component parallel to the axis of the coil. FIG. 5 shows a member 10 forming an offset spiral, where, like the helical form of FIG. 4, the secondary curve has a component both about the axis of the coil and parallel to the axis of the coil and where the radius of the secondary curvature increases along the member. FIG. 6 shows a member having a straight portion 100 adjacent to a toroid shaped portion 101. The slit 3 in the tube is intrados to the secondary curve in this example. FIG. 7 shows a member 10 having a straight portion 100 adjacent to a toroid shaped portion 101 where the slit 3 in the tube is extrados to the secondary curve (i.e. the toroid curves in the opposite direction to the member of FIG. 6). FIG. 8 shows a member 10 having a straight portion 100 adjacent at each end to a toroid shaped portion 101.

Forming coilable extendible members 10 with secondary curves gives rise to various challenges both in manufacture and in the performance of the structures themselves.

Compared with a STEM structure 10 having no secondary curvature in its extended form (i.e. a conventional straight member), a STEM structure having a secondary curvature of any significance gives rise to a higher peak strain when being coiled due to the compound nature of the curve. In simple terms, if the primary curvature is present on its own, the strain energy resulting from its being coiled will be a simple function of this curvature and the nature of the materials used. If a second curvature is introduced resulting in a compound curve the resulting strain energy will result from the deformation of both curvatures, which will be of greater magnitude than in the first case. Thus, a member with primary and secondary curvature takes more energy to coil, which has greater potential to fracture the member or otherwise shorten its lifespan and the number of cycles of extension/coiling.

FIG. 9 shows an example of a layup 200 for a composite STEM member 10 where fibres on one or both outer layers P1 and P5 are angled with respect to the longitudinal axis and the fibres in the inner layers P2, P3 and P4 are aligned with the longitudinal axis (P2 and P4) or perpendicular to the longitudinal axis (P3). This is a typical arrangement of fibres for a bistable member. In this example, however, the angle of the fibres 201 in the P1 and P5 layers is not constant across the width 202 of the member 10. The angle to the longitudinal axis 203 decreases towards the side edges 215 of the member 10. The fibres may for instance have a substantially sinusoidal curve across the width of the member. The fibres may be angled at 30 degrees at the edges 211,212 and 40 degrees towards the middle 210. This achieves a lower strain at the edges 211,212 when the member 10 is coiled/uncoiled, which increases the resistance of the member 10 to breaking. At the same time, bistability of the member 10 may still be achieved if desired.

Thus, a STEM type structure 10 can be formed in which the direction of fibre reinforcement is modified around the hoop of the extended member 10 and/or along the axis of the member 10 in such a manner as to reduce the peak strain in the member 10 during coiling. For instance, FIG. 16 shows a plot of strain in a STEM along a portion of the member 10 transitioning from an extended form to a coiled form. Line ‘a’ shows the increase in strain to be expected when a conventional STEM is opened out at the slit and coiled, reaching a maximum aₚₑₐₖ when fully opened, Line ‘b’ shows the reduction in peak strain bₚₑₐₖ that can be achieved by using the methods described herein, which can aid coiling the member by hand for example and extend the life of the member.

Furthermore, a STEM type structure 10 can be formed in which the direction of fibre reinforcement is modified around the hoop of the extended member 10 and/or along the axis of the extended member 10 in such a manner as to reduce the peak strain in the structure during coiling and in such a manner as to cause the STEM to exhibit bi-stability. Line ‘c’ in FIG. 16 shows the strain increasing towards a peak cₚₑₐₖ as the member 10 is opened out at the slit. before “flipping” into a second coiled form having a lower strain, thus allowing the member to exhibit bistability. This means the member 10 can be stored in a coiled form without constraint because it has little or no tendency to “explode” due to the stored strain energy.

A STEM type structure 10 can be formed in which all or part of the reinforcement has the property of being possessed of a negative Poisson's ratio, thus producing a structure in which the coiling such that the intrados face of the extended structure becomes the extrados face of the coiled structure when coiling in such a manner as to produce the lowest peak and mean strain within the structure during coiling, contrary to normal stress-strain relationships during coiling.

Although no absolute prohibition is known to the designing and coiling of a structure such as this in which the slit giving the STEM class their name runs along an axis or variable path other than the intrados or extrados line of the secondary curve it is expected that normal practice will be to place the slit, or open face in the case of a carpenters tape measure type structure, along the intrados line of the secondary curve, which will normally show the lowest peak and mean strain during coiling, except where negative Poisson's ration materials are concerned, in which case this will be with the slit running along the extrados line of the secondary curve.

Using an elastomer matrix allows very high strains to be tolerated by the member without fracture. Similarly tough fibres, such as glass, may be used to prevent fracture when coiling.

The strain experienced by the member during coiling may be high and still allow curvature using urethane rubber and glass fibres.

When coiled, the edges preferably lap edge to edge to reduce the size of the coil in the axial direction. The member may be wound on a bobbin having edges that help align and constrain the edges to lap edge to edge.

The member 10 may be manufactured in coiled form, either with constant or variable curvature, and possess a combination of curvature combined with fibre structure with respect to the longitudinal axis such that when extended the member acquires a secondary stable form with a secondary curvature.

FIG. 10 shows an example of a layup where the composite member 10 has additional local fibre reinforcement 220 across the width of the member to control the degree of shrinkage of the matrix when curing the member 10. All polymers and thermoplastics shrink to some degree when being cured/set. In this example, in layer P3, axial fibres 220 are present towards the middle 210 of the member and do not extend to the edges 211,212. When the matrix is cured, it has a tendency to shrink. This tendency is resisted to a greater degree by the areas with additional reinforcement. Thus, where the member 10 is consolidated and cured on a former 250 (e.g. as shown in FIG. 11), pre-stresses arise due to the shrinkage of the matrix which are lower for the reinforced areas than the other areas. When removed from the former, the reinforced areas contract less and, due to the primary curve of the member 10, this gives rise to a secondary curve in a direction similar to the axis of coiling in the coiled form. The reinforcing fibres 220 do not have to be axial. Similar results can be achieved by fibres with any significant orientation to the longitudinal axis, such as at least 60 degrees to the longitudinal axis 203. Alternatively, the fibres 220 can run to the edges 215, but have a greater angle with respect to the longitudinal axis 203, such that they offer less resistance to shrinkage in that direction.

As will be appreciated, the reinforced sections 210 can be configured differently to achieve different effects. For instance, reinforcing the edge portions 211,212 rather than the middle portion 210 can cause a curvature in the opposite direction. Reinforcing one edge portion 211 more than the other edge portion 212 can cause the member 10 to deflect to one side, i.e. in a direction parallel to the axis about which the member coils in the coiled form, to help achieve spirals and helix type curvatures.

The curvature may be achieved, in whole or in part by these techniques, with or without other techniques described herein. Furthermore, some degree of control over the curvature can be achieve by making use of the natural tendency for composite STEMs to curve after manufacture due to a combination of shrinkage in the matrix polymer and the lower axial rigidity shown in some composite structures towards the unsupported edges.

Composite STEMs can also be made in such a manner as to engineer the basic material constants such as isotropy and Poisson's ratio in such a manner as to lend itself well to bending or coiling in a particular manner.

Composites also lend themselves well to being made on formers that have complex shapes, FIG. 11 shows an example of a STEM 10 being made on a toroid shaped former 250 to achieve a toroid shaped member when extended. A STEM type structure may be formed in which the shape is derived from being formed on a male or female mould of the desired shape.

Where a former 250 is used with the shrinkage techniques described above, such that pre-stresses arise in the member as the matrix is cured, the member may be constrained by vacuum bagging, using a clam shell male and female part mould, winding shrink tapes around the mould, as known per se in the composite manufacturing field, or any other suitable technique. By providing pressure, the fibres are prevented from buckling as the matrix shrinks.

In one example of manufacture, the product is consolidated on the flat before being formed in the desired curved extended form. FIG. 12 shows apparatus for continuous manufacture of the product in which the product is consolidated on the flat. This extends the principles developed in the applicants' international patent application, published as WO2014118523A on 17 Aug. 2014, the entire contents of which are incorporated by reference herewith.

Briefly, The apparatus 20 also comprises a belt press 30, which are known per se. In the present example, the belt press 30 comprises a pair of driven, back-to-back conveyors 32,34. The belt press 30 has pressure rollers 36 or the like arranged to controllably exert pressure to a workpiece passing through the belt press 30 between its conveyor belts 32,34. The belt press 30 also has heaters 38 adjacent to one or both conveyor belts 32,34 to heat the workpiece as it is passed through the belt press 30 between the conveyor belts 32,34.

A controller 40 is provided to controls the operation of the belt press, i.e. drive the belts at a selected speed, selectively apply heat and or pressure to the workpiece in the belt press, either automatically or semi automatically in response to suitable inputs from an operator. The controller 40 is preferably a computer system or other electronic system. The controller 40 or a separate controller can also control other aspects of the apparatus, such as the heating/cooling of the dies to achieve a desired temperature.

The upper and lower conveyor belts 24,26 of the conveyor belt assembly 22 pass through the conveyor belt pair 32,34 of the belt press 30. Preferably the conveyor belts 24,26 are “parasitic” on the conveyor belts of the belt press 30. In other words, they are moved via frictional forces with the conveyor belts of the belt press 14.

Alternatively or additionally, the conveyor belts 24,26 may be driven by other drive means, such having one or more of the rollers 28 being driven by a motor, under control of the controller 40.

The apparatus 20 has a feed on area 50 upstream of the conveyor assembly 22 where reels of component material are mounted on spindles/axles 50. In the present example, the component materials include reels of prepreg 54, i.e. fibre arrays that have been already impregnated with matrix. The component materials 50 also optionally include fibre optic cable 56. Other component materials may be used according to the desired finished product. Also in the feed on area 50, the apparatus 20 has feed guides 60 to guide the component materials 50 into the conveyor assembly 22 and optionally tensioners 61 to tension the fibre optic cables 54 to an appropriate tension.

The components 50 are then drawn through by the conveyor assembly 22. The components 50 are first consolidated on the flat by the belt press 30 to produce a ribbon-like consolidated composite 57. The preliminary application of heat and pressure needed for consolidating of the component materials is first carried out between flat pressure rollers 36 of the belt press by the application of heat and or pressure. This consolidation process ensures a close joining of the parts on a flat surface and aims to eliminate or at least reduce air bubbles, voids, etc. between the components in the laminate product. The components 57 are heated to the point of being tacky and pliable during this consolidation process, but are not fully cured/set at this stage.

The apparatus 20 includes a die assembly 70 after the belt press 30 where the consolidated composite 57 is shaped and set. The conveyors 24,26 pass into the die with the consolidated composite and remain in contact with the consolidated composite as it passes through the die assembly 70. Thus, the conveyors 24,26 and not the consolidated composite 57 is in contact with the die assembly 70.

The die assembly 70 has a hot forming section 71 through which the flat consolidated composite 57 exiting the belt press passes first. In the hot forming section 71, the die assembly 70 shapes the consolidated composite to a constant, non-flat cross section and heat is applied to set the materials into their shaped form. The die assembly 70 also has a cold forming section 72 after the hot forming section 71 where the shaped composite is cooled to the point where it is cool enough to take off and either coil or cut ready for storage or use. The apparatus 80 has a feed off area 80 after the end of the conveyor assembly 14 where the finished product is coiled and or cut. Preferably the cold forming section 71 guides the product back to having a flat cross-section as it exits the die assembly 70 to aid passing through the rollers 20 at the end of the conveyor assembly 14. This also helps in coiling and or cutting the finished product to length.

The die 71 in this example is arranged to give the desired primary and secondary curvature to the STEM. Thus, as well as providing curvature to the member 10 in cross section, the die imparts a secondary curvature along the longitudinal length of the member, e.g. parallel to the axis about which the member coils in its coiled form.

The press consolidates the components on the flat, which by applying pressure and optionally heat to partially melt the binder. Consolidating on the flat is simpler and more effective compared with trying to consolidate the components with a non-flat profile as for example prior art techniques such as vacuum moulding, etc.

A double conveyor is used to pull the product through a die stage to shape the profile of the consolidated components to a desired cross sectional form and to set the product into that shape by the application of heat. The die can be any arrangement shaped to hold the belts in conformance with the desired finished provide. The die may constrain the belts through some or all of the transition from the flat to the desired non-flat profile, or the die may just allow this transition to take place in an unconstrained length of belt between the flat state and the die profile. Little or no pressure need be applied to the consolidated components in the die stage to set the product. The use of conveyors passing through the die which “sandwich” the product as it is shaped in the die means that the product experiences little or no shear forces with the surfaces of the die as it is pulled through the die, which is important given the product is tacky and to maintain the alignment of the components of the composite, e.g. the reinforcing fibres.

Thus, the technique produces shaped composites with high accuracy in the placement of the component which is key in many applications to achieving the desired properties of the composite.

The belts may be formed from a substantially elastomeric material, such as silicone or other temperature tolerant rubber, with or without fabric reinforcements, to allow the belts to tightly conform to the shape of the die.

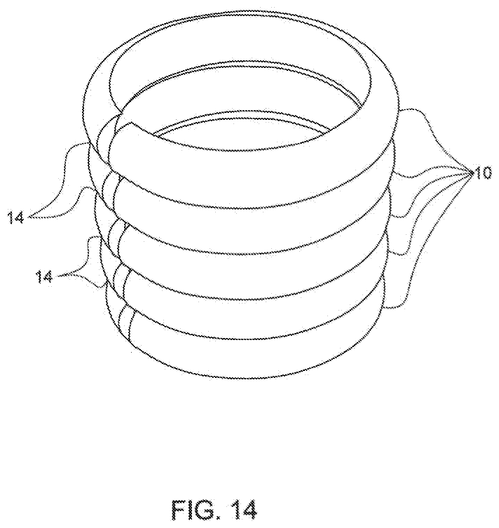

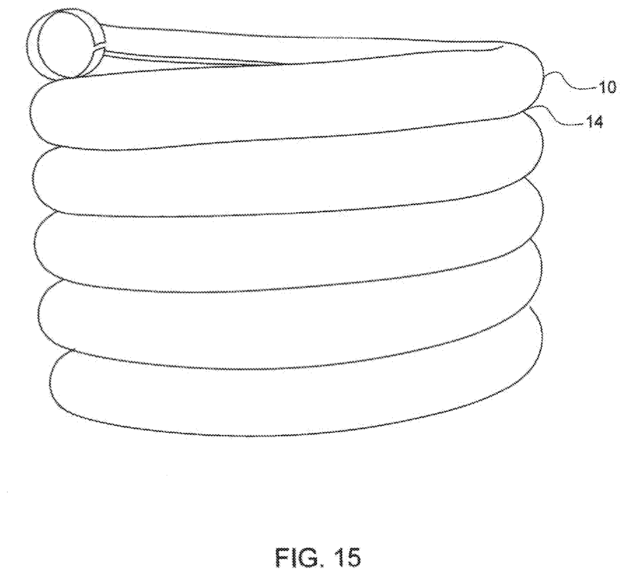

As shown by FIGS. 13 to 15, a member or members 10 may be linked along the edges 14 or axially in such a manner as to form a rigid or semi-rigid structure from the linked members. FIG. 13 shows members 10 linked to form linked arches. FIG. 14 shows members 10 linked to form semi toroids. FIG. 15 shows a member 10 linked to itself to forma contact helix. Such methods may be combined to form hybrid structures in any manner found to be of utility for a particular task.

Embodiments of the present invention have been described with particular reference to the example illustrated. However, it will be appreciated that variations and modifications may be made to the examples described within the scope of the present invention.

1. An extendible member which is configurable between a coiled form and an extended form, comprising a longitudinal shell resiliently biased in a slit tube form in which it has a first curvature relative to the hoop of the slit tube and has a secondary curvature relative to the longitudinal axis of the member, wherein the slit tube can be opened out at the slit to assume an open form in which it has a flattened cross section in transitioning from the extended form to the coiled form, wherein the strain energy when coiled is lower than the peak strain energy in the member when transitioning from the extended to the coiled form.

2. An extendible member having a secondary curvature when extended, running substantially along the axis of extension or retraction.

3. The extendible member according to claim 1, wherein the secondary curvature is a conic section, regular or irregular spline curve or spiral or helical curves or any other curve or combination of curves or combination of curved and straight sections

4. The extendible member according to claim 1 in which the direction of fibre reinforcement is modified around the hoop of the extended structure in such a manner as to reduce the peak strain in the structure during coiling.

5. The extendible member according to claim 1 in which the direction of fibre reinforcement is modified along the axis of the extended structure in such a manner as to reduce the peak strain in the structure during coiling.

6. The extendible member according to claim 1 in which the direction of fibre reinforcement is modified around the hoop of the extended structure in such a manner as to reduce the peak strain in the structure during coiling and in such a manner as to cause the member to exhibit bi-stability.

7. The extendible member according to claim 1 in which the direction of fibre reinforcement is modified along the axis of the extended structure in such a manner as to reduce the peak strain in the structure during coiling and in such a manner as to cause the member to exhibit bi-stability.

8. The extendible member according to claim 1 in which all or part of the reinforcement has the property of being possessed of a negative Poisson's ratio, thus producing a structure in which the intrados face of the extended structure becomes the extrados face of the coiled structure when coiling in such a manner as to produce the lowest peak and mean strain within the structure during coiling, contrary to normal stress-strain relationships during coiling.

9. A method of forming an extendible member according to claim 1, in which the shape is derived from being formed on a male or female mould of the desired shape.

10. A method of forming an extendible member according to claim 9 in which the form produced by a mould is modified by the effects of shrinkage or local reinforcement acting to prevent shrinkage.

11. A method of forming an extendible member according to claim 1 in which the shape is derived from a composite material being consolidated on the flat whilst enclosed on both faces by conveyor type belts and then being passed, along with said belts, through a die that imparts both primary and secondary curvature.

12. A method of forming an extendible member according to claim 1 in which the curvature, in whole or in part, derives from or is modified by the local effects of shrinkage in the matrix polymer or adjustments in reinforcement such as to prevent shrinkage locally.
